(19) United States
(12) Patent Application Publication
(10) Pub. No.: US 2006/0059498 A1
(43) Pub. Date: Mar. 16, 2006

(54) System to process structured input data for interactive terminal applications

(76) Inventor: James F. Christofferson, Aurora, IL (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/211,074

(22) Filed: Aug. 25, 2005

Related U.S. Application Data
(60) Provisional application No. 60/604,052, filed on Aug. 25, 2004.

(51) Int. Cl. G06F 9/46; G06F 3/00

(52) U.S. Cl. 719/318; 703/23; 710/6

(57) ABSTRACT

A system to pre-process a raw data stream of structured data from a new data source for input to interactive software applications. The terminal emulation program for the interactive application is modified to identify the raw data stream from the new data source, and to provide entry points for transmitting data to the application and for retrieving an input screen and current cursor position. These entry points are used by a processing module, which receives the identified raw data stream from the emulation program, processes the raw data stream in accordance with a definition file, which contains a mapping of the raw data stream of structured data to input data fields on input screens of the interactive application. The definition file also indicates how to navigate between input screens. The processing module then populates the input data fields on their respective input screens, via the terminal emulation program.

### BACKGROUND OF THE INVENTION

1. Field of the Invention

The present invention generally relates to terminal emulation systems and, in particular, to a conversion interface enabling use of existing interactive applications without modification to implement new technology having different data sources, such as radio frequency identification (RFID) technology.

2. Background Description

Commerce is reflected in the manufacture, delivery, and inventory management of products and supplies. More efficient techniques for tracking and managing products throughout the supply chain provide significant competitive advantage to suppliers and distributors. Recent technology advances in RFID hold promise for providing such improvements in the efficiency of tracking and management products. The basic concept in tracking is to apply a tracking tag to a product, and then read the tag as the product changes location. RFID tags operate by having a passive radio frequency transmission capability that is triggered by a signal from a reader.

The cost of these tags has reached a level where use is more viable than in the past. Although RFID technology was developed in the 1940's and has been used in particular commercial applications for some thirty years, the cost of the tags and other practical issues have prevented general use as a preferred product tracking technology. As an indication of the improving commercial viability of RFID technology, Walmart now mandates that its suppliers provide RFID technology with product deliveries. The RFID technology allows the product to be automatically located, identified, and counted by RFID readers which are capable of generating large volumes of highly structured data. The Department of Defense is mandating a similar program for its suppliers, and it is predicted that this technology will eventually be widely adopted in retail, manufacturing, and logistics.

Currently, this functionality is provided by bar code scanning technology in conjunction with interactive applications, such as shipping and receiving programs. Bar codes are applied to product, and bar code scanners are used to read these codes. For example, product stored in a warehouse may be inventoried by personnel going through the warehouse with mobile bar code readers and scanning the bar codes visible on product containers. This generates a large volume of asynchronous data that must be gathered into a common repository. See U.S. Pat. No. 5,513,328 to the present inventor for technology for handling large volumes of asynchronous data from multiple devices such as bar code readers.

Bar code readers require a visual line of sight between the bar code on the product and the bar code reader. This limitation is overcome by RFID technology, which uses electromagnetic waves in the radio frequency spectrum rather than visible light. However, existing interactive applications for tracking product moving through the supply chain have been designed to interface with bar code technology. Further, it is likely that bar code technology will continue to be used, even as RFID technology becomes a more commercially viable solution for product tracking in particular circumstances. For example, in the warehouse example given above, in circumstances where time delay for personnel to traverse a warehouse is not acceptable, or it is not acceptable to overlook product whose bar code is hidden from view, the RFID option is preferable.

However, the effort, time, and cost to develop new interfaces for existing interactive applications, or to develop new or replacement applications, in order to comply with the mandates to use RFID technology, is significant, both for suppliers and distributors. This is seen as one of the primary impediments to the implementation of RFID technology. It would therefore be advantageous to have a system for using existing interactive applications without requiring changes in the applications in order to use RFID technology.

### SUMMARY OF THE INVENTION

It is therefore an object of the present invention to provide a system for implementing RFID technology in interactive product inventory and management applications without requiring modification of the existing interactive applications.

Another object of the invention is to provide a system usable for transitioning from barcode scanning technology to RFID technology using existing interactive applications without modification.

A further object of the invention is to provide a mechanism for automatically navigating the interactive screens of an application designed for structured data from an existing source in order to populate those screens with structured data from a different source having a different structure.

The invention operates by providing an improvement at the point of the terminal emulation interface serving the applications using the tracking data provided by bar code technology. The system and method of the invention provides a mechanism for populating the input screens of the application with the data elements drawn from the data stream of structured data coming from RFID data sources. This enables the application to use the tracking data provided by RFID technology.

The invention provides a system for processing a raw data stream of structured data from a new data source, and then navigating the interactive screens designed for an existing source of structured data in order the populate existing input data fields on multiple interactive input screens with data from the new data source. The system is responsive to a situation where an existing interactive application is not adapted to receive the raw data stream of structured data from the new data source. It is assumed that the existing application is adapted to place incoming data into a plurality of input data fields in one or more input screens. It is also assumed that there is a terminal emulation program for receiving incoming data for the application. For implementation of the invention, the emulation program is modified to identify the raw data stream from the new data source, and to provide entry points for transmitting data to the application and for retrieving an input screen and current cursor position. These entry points are used by a processing module, which receives the identified raw data stream of structured data from the emulation program, processes the raw data stream of structured data in accordance with a definition file, and then populates the input data fields of the existing interactive application on its respective input screens, via the terminal emulation program.

In another embodiment, the invention provides a method for processing a raw data stream of structured data from a new data source. It first generates a definitions file. It then processes the raw data stream using data definitions in the definitions file to map the structured data to input data fields on input screens of an interactive application. There is a sequence of the data input fields to which the interactive application is adapted, and the structured data from the new data source is not in that sequence. Finally, the invention then populates the input data fields by navigating to the input screens and input data fields using screen definitions and navigation definitions contained in the definitions file.

The system identifies and separates the raw data stream of structured data into discrete data elements, and then automatically submits the data elements via one of several possible terminal emulation protocols, and in the sequence required by the interactive application. With this invention, existing applications require no modification, and the effort required to implement RFID technology is relatively trivial.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a schematic showing a high level menu pull-down structure for the administration utility component of the invention.

FIG. 2 shows a grid for displaying the raw data stream in the data definition process used by the invention.

FIG. 3 is a schematic representation of the relation between the administration utility and the processing module in providing definitions to the processing module.

FIG. 4A shows the relation between a plurality of emulation programs and the processing module.

FIG. 4B is a schematic showing the path of data from a data source to the application via an emulation program to the processing module and from the processing module to the application.

FIG. 4C is a schematic showing interaction between the processing module and the application, via the emulation program, for writing data to the application.

FIG. 5 is a schematic showing exemplar data fields positioned on screens of the applications.

### DETAILED DESCRIPTION OF A PREFERRED EMBODIMENT OF THE INVENTION

The invention uses an administration utility as a standalone graphical user interface (GUI) program. The administrative utility program a) defines the data input elements and any required pre-processing (i.e., character additions, deletions, and substitutions), b) defines application screen and cursor positions for the data elements, and c) defines the keystrokes and commands required to navigate the application screens.

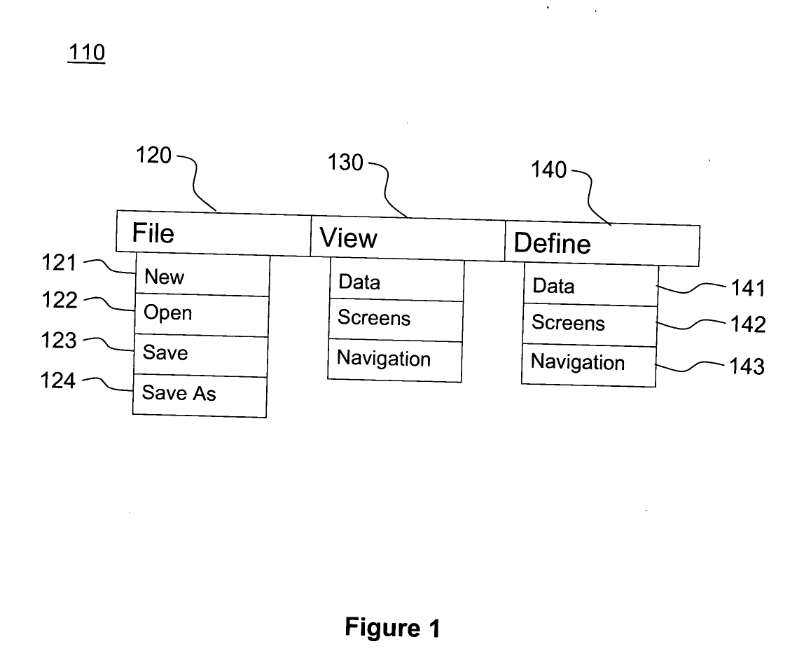

The functions of this utility program may be understood with reference to FIG. 1, which shows a high-level pull-down menu structure for the utility. The basic GUI functions are file operations 120, view operations 130 and define operations 140. File operations 140 involve creation, naming, and saving of the output file, which stores the data, screen, and navigation definitions. The particular operations required for file functions are creation of “new” files 121, a “save as” operation for naming a new file 124, “open” an existing file 122, and “save” for saving changes to an existing file 123.

View operations 130 include viewing current data, screen, and navigation definitions. Where multiple data, screen, and navigation definitions are present, another pull-down menu is used to select the one of interest.

Define operations 140 create and modify data, screen, and navigation definitions. Where multiple data, screen, and navigation definitions are present, another pull-down menu is used to select the one of interest.

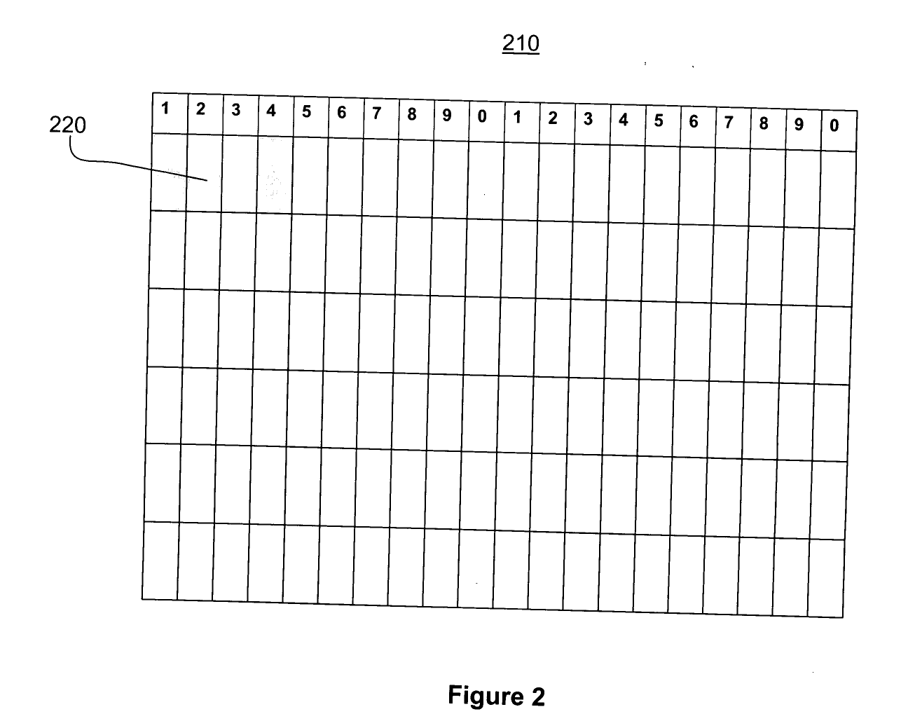

Data definitions 141 are created using the data stream provided by the new data source (e.g. the source of the RFID data). In the best mode of implementation, this is accomplished using a grid display 210 as shown in FIG. 2 and a drag-n-drop mouse operation to define individual data elements. These data elements may appear in the data stream either as fixed length fields or separated by delimiter characters. A computer mouse is dragged across the grid to identify each data element (e.g. highlighted data element 220) in the order it appears in the raw data stream.

After the element (e.g. 220) is highlighted, the user right clicks the mouse for a submenu to a) Assign the element to one or more predefined application screens and positions within those screens, or b) define Edit operations to be performed on the element prior to submission to the application, or c) define a Delimiter character or character sequence. As the database of standard data formats is compiled, a menu option to select from that database is also provided to simplify the process.

Returning to FIG. 1, the menu for the definitions of screens 142 allows the user to a) Capture and name application screens, and to b) Edit screens that have been captured for defining screen identification strings and input fields, and (for VT emulations only) manipulating the locations and lengths of input fields. The menu for navigation definition 143 displays an icon for each named screen and allows the user to define the screen hierarchy using a drag-n-drop mouse operation. The resulting links between each screen can then be selected with the mouse, and then right-clicked to provide a submenu for definition of the actions necessary to navigate between screens.

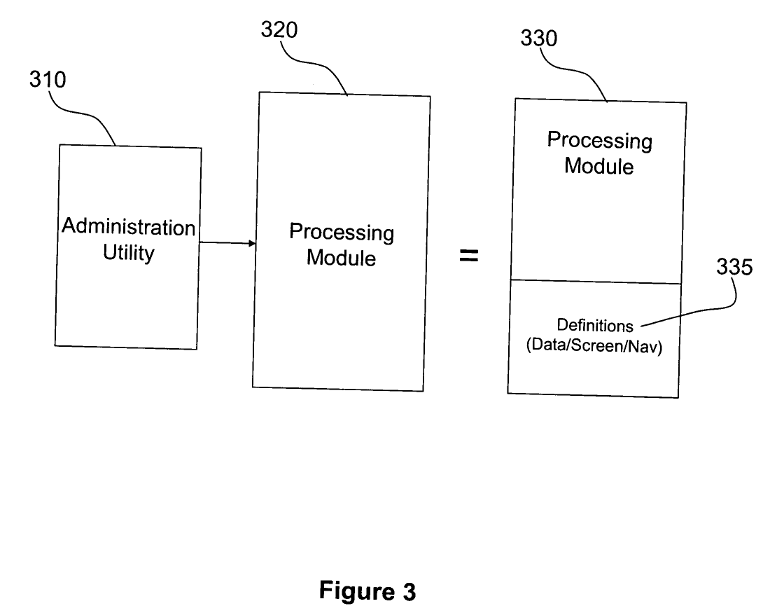

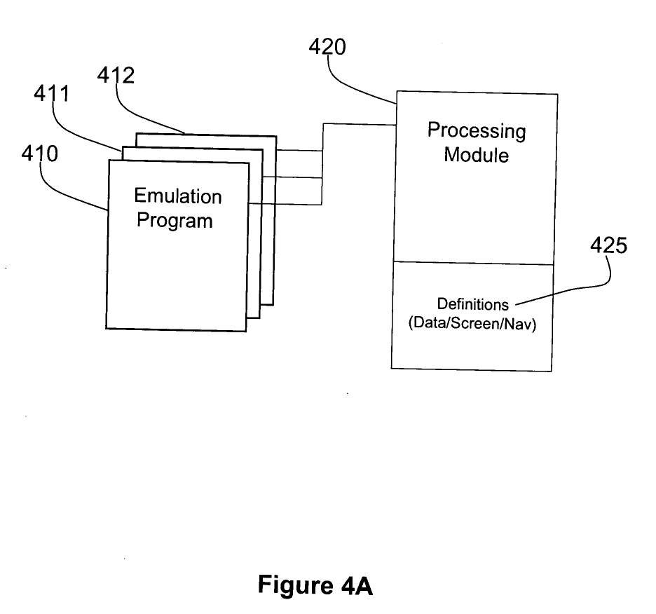

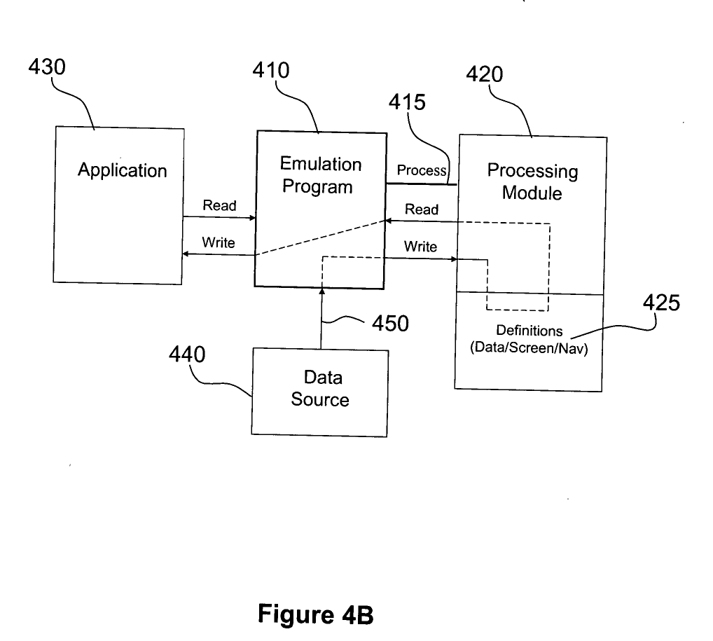

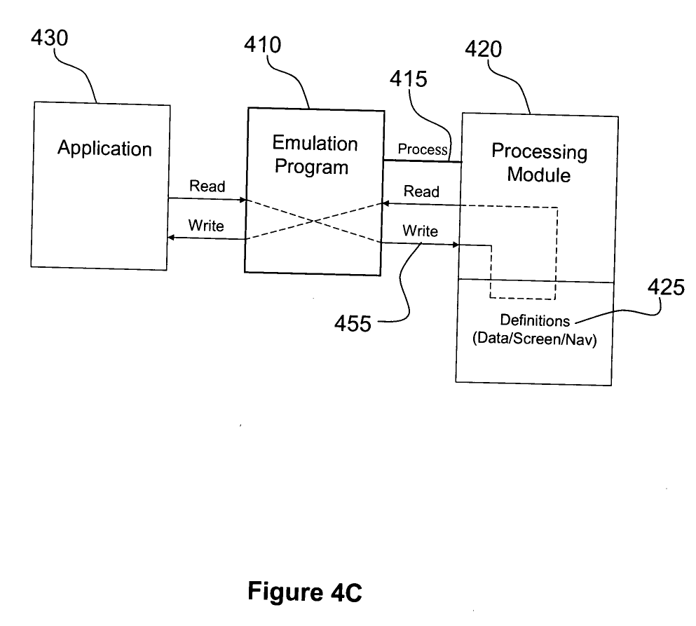

As shown in FIG. 3, the output of the administration utility 310 is a formatted data file that is the input to the processing module 320. The result 330 is a processing module having access to the definitions 335 generated for data, screen and navigation by the administration utility 310. The processing module 420 is a program library module linked to each of the terminal emulation programs as shown in FIG. 4A. The library contains functions for reading the file 425 created by the Administration Utility 310 and processing raw structured input data received by the emulation programs accordingly.

The entry point to the processing module 420 is a function with an argument to convey the raw structured input data. This function is called 415 by the emulation program upon receipt of structured input data from the data source 440, as shown in FIG. 4B. The path 450 of this structured input data is from the data source 440 to the emulation program 410 and then to the function, in the processing module 420, which parses and edits the data elements of this structured input data as specified in the definitions 425. Upon successful completion of parsing and editing of a data record, the processing module 420 navigates the screens of the application 430 via screen read and data write calls 415 to the emulation program, with data elements being written in the sequence required by the application 430. The read and write operations are implemented as shown by path 455 in FIG. 4C, as dictated by the navigation definitions 425. The read and write operations shown in FIGS. 4B and 4C are shown from the viewpoint of the emulation program 410, through which processing module 420 acts.

After the processing module 420 locates the correct screen and navigates to the correct input field position, the data element is written, as shown by path 450 in FIG. 4B. Path 450 continues in the direction of the arrows along the dotted line in the processing module 420 and along the dotted line in the emulation program 410 to the application 430. In the event of a failure (e.g., an unrecognized or erroneously defined data structure, or a navigation failure), the processing module 420 returns an error code to the emulation program 410, which notifies the terminal user.

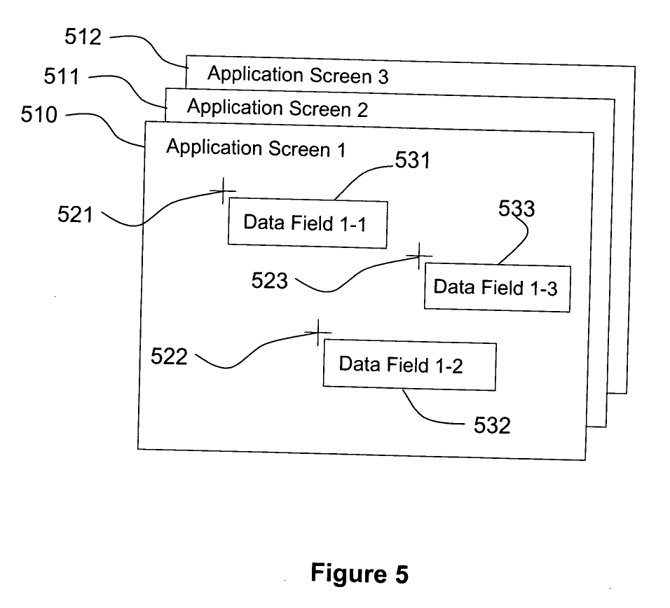

This is repeated for the other data elements, corresponding to the input data fields, contained in the parsed and edited record received in the raw data stream from the data source 440, in the sequence required by the application 430. This process populates the data fields of input screens of the application 430 as shown in FIG. 5. For the example of FIG. 5, the application 430 contains three input screens (510, 511 and 512), each having data fields (e.g. 531, 532 and 533) to be populated from the raw data stream. Also shown on FIG. 5 are the screen locations (521, 522 and 523) for the respective data fields (531, 532 and 533). Once the parsed and edited record in the raw data stream containing the structured information has been processed to populate the data fields of the of the input screens of the interactive application 430, the application 430 processes the record, clears its input screens and signals it is ready for the next record from the raw-data stream. In this manner the application 430 is able to process the raw data stream of structured data from a data source 440 differently organized from what is expected by the existing interactive application 430. For example, the new data source may provide a raw data stream of structured data in accordance with RFID technology.

In order to accomplish this result each emulation program 410 (e.g., VT, 5250, and 3270) is modified to identify differently structured data (e.g., input from an RFID reader) and call the processing module 420 with the data 450, so that the data can be suitably processed by the processing module 420 in accordance with the definitions 425 generated by the administration utility (i.e. 310 in FIG. 3). Each emulation program 410 must also provide two entry points for the processing module: one for transmitting data to the application, and another for retrieving the application screen and current cursor position.

While the invention has been described in terms of a single preferred embodiment, those skilled in the art will recognize that the invention can be practiced with modification within the spirit and scope of the appended claims.

Having thus described my invention, what I claim as new and desire to secure by letters patent is as follows:

1. A system for processing a raw data stream of structured data from a new data source, comprising:
an interactive application not adapted to receive the raw data stream from the new data source, the application being adapted to place incoming data into a plurality of input data fields in one or more input screens;
a terminal emulation program for receiving said incoming data for the application, the emulation program being modified to identify the raw data stream of structured data from the new data source; and
a processing module for receiving the identified raw data stream, the processing module being adapted to populate said plurality of input data fields from said structured data in said raw data stream via said terminal emulation program by navigating to said input screens and said input data fields in a sequence to which said interactive application is adapted for said incoming data.

2. A system as in claim 1, wherein the processing module has a definitions file, the definitions file comprising:
data definitions mapping the raw data stream of structured data to said plurality of data fields;
screen definitions for identifying said input screens and said input data fields on said input screens; and
navigation definitions for navigating between the input screens.

3. A system as in claim 1, wherein said terminal emulation program provides entry points for the processing module, the entry points being
for transmitting data to the application, and
for retrieving an application input screen and a current cursor position on the input screen.

4. A system as in claim 2, wherein the definitions file is created by an administration utility, the administration utility being a standalone graphical user interface program.

5. A system as in claim 2, wherein the processing module contains functions for reading the definitions file.

6. A system as in claim 1, wherein the processing module services a plurality of emulation programs.

7. A system as in claim 1, wherein the processing module writes to an input data field after locating a screen and a location on the screen of the input field location.

8. A method for processing a raw data stream of structured data from a new data source, comprising:
generating a definitions file;
processing the raw data stream using data definitions in the definitions file to map the structured data to input data fields on input screens of an interactive application, there being a sequence, of said data input fields to which the interactive application is adapted, wherein said structured data is not in said sequence; and
populating the input data fields on said input screens of the interactive application by navigating in said sequence to said input screens and input data fields using screen definitions and navigation definitions in said definitions file.

9. A method as in claim 8, wherein a terminal emulation program receives incoming data for the application and the emulation program is modified to identify the raw data stream of structured data from the new data source.

10. A method as in claim 9, wherein said processing and populating are performed by a processing module, the processing module containing functions for reading the definitions file.

11. A method as in claim 10, wherein said terminal emulation program provides entry points for the processing module, the entry points being
for transmitting data to the application, and
for retrieving an application input screen and a current cursor position on the input screen.

12. A method as in claim 8, wherein generating the definitions file further comprises:
mapping the structured data in the raw data stream to the input data fields;
identifying the input screens and the input data fields on said input screens; and
determining links for navigating between the input screens.

13. A method as in claim 11, wherein the definitions file is created by an administration utility, the administration utility being a standalone graphical user interface program.

14. A method as in claim 13, wherein the processing module services a plurality of emulation programs.

15. A method as in claim 14, wherein the processing module writes to an input data field after locating a screen and a location of the input field location on the screen.

16. A computer implemented system for processing a raw data stream of structured data from a new data source, comprising:
first computer code for generating a definitions file;
second computer code for processing the raw data stream using data definitions in the definitions file to map the structured data to input data fields on input screens of an interactive application, there being a sequence of said data input fields to which the interactive application is adapted, wherein said structured data is not in said sequence; and
third computer code for populating the input data fields on said input screens of the interactive application by navigating in said sequence to said input screens and input data fields using screen definitions and navigation definitions in said definitions file.

17. A computer implemented system as in claim 16, further comprising a terminal emulation program for receiving incoming data for the interactive application, the emulation program being modified to identify the raw data stream from the new data source.

18. A computer implemented system as in claim 17, wherein said terminal emulation program provides entry points for transmitting data to the application, and for retrieving an application input screen and a current cursor position on the input screen.
